(19) United States
(12) Patent Application Publication
(10) Pub. No.: US 2008/0126007 A1
(43) Pub. Date: May 29, 2008

(54) Method and a System for Locating Objects in a Defined Area

(75) Inventors: Tal Bareket, Kiryat Tivon (IL); Noam Pinski, Kineret-Moshava (IL); Hagai Plexer, Ramat HaGolan (IL)

Correspondence Address: FRISHAUF, HOLTZ, GOODMAN & CHICK, PC, 220 Fifth Avenue, 16TH Floor, NEW YORK, NY, 10001-7708, US

(73) Assignee: S.A.E. AFIKIM COMPUTERIZED DAIRY MANAGEMENT SYSTEM, Kibbutz Afikim (IL)

(21) Appl. No.: 11/573,080

(22) PCT Filed: Aug. 3, 2005
(86) PCT No.: PCT/IL05/00828

§ 371 Date: Nov. 5, 2007

(30) Foreign Application Priority Data
Aug. 4, 2004 (IL) 163360

(51) Int. Cl. G01C 15/00

(52) U.S. Cl. 702/150

(57) ABSTRACT

A method and a system for locating objects in a defined area, such as for locating animals in a pen, wherein each segment of the defined area is projected by a narrow angle projection; and the projection is modulated, the modulation including the location of the segment being projected. A self-location-unit is attached to each object for receiving the projection, decoding the modulation having the self-location segment, and transmitting the self-location. A receiver receives each transmission from each self-location-unit, and stores each object's location segment. The system has at least one projector which periodically scans at least part of the defined area, and produces the narrow angle projection that is modulated with information about the location that is being projected. At least one stationary unit receives the self-location information from each object's self-location-unit and displays and/or stores the received locations.

### FIELD OF THE INVENTION

The present invention relates to the field of objects locating systems. More specifically, the present invention relates to a system for locating identified object, especially moving objects, in a defined area.

### BACKGROUND OF THE INVENTION

Location methods can be grouped, generally, to “location” and “identified location”. The “location” methods, e.g. radar, ultra-sound and imaging, are locating objects without identifying which-is-which. The “identified location” locates an object with identification and the location includes the identification of the object that is being located. Systems that use “identified location” have an identification system that is integrated with the location system.

An identified object must have an identification means on it. For example, the object can have a transponder that transmits an identifying code in response to a predetermined signal and enables the location system to identify it, in another example the object can have a barcode or color barcode for identifying by image processing while using an image location system.

The present invention relates to the “identified location” systems. Systems that implement methods of “identified location” are either complicated or expensive or having low resolution.

Therefore, it would be advantageous to have a method and a system, for locating and identifying objects in a defined area that is simple, reliable and inexpensive.

### SUMMARY OF THE INVENTION

The present invention is a method and a system for locating objects in a defined area. The present invention is useful for location of animals in a pen.

According to the teachings of the present invention there is provided a method for locating objects in a defined area, the method is comprised of the following steps:
projecting each segment of the defined area by a narrow angle projection;
modulating the projection, wherein the modulation includes the location of the segment being projected;
attaching a self-location-unit to each object, this self-location-unit capable to receive the projection, decodes the modulation having the self-location segment, and transmits the self-location; and
receiving each transmission, from each self-location-units, and storing each object's location segment.

According to present invention, the method is also provided, wherein the self-location-unit includes an identification code and this code is attached to any transmission of the self-location unit in order to identify the object from which the transmission is received.

According to present invention, the method is also provided, useful for moving objects and further includes at least one of the following steps:
receiving sequentially the transmissions from the self-location-units, enabling real time location of each object.
sequentially storing each object's location for further processing.

According to present invention, the method is also provided, wherein the projection is done by a single projector that periodically scans the whole segments of the defined area and changes modulation in accordance with the location of the segment being projected.

According to present invention, the method is also provided; wherein the scanning is done by a plurality of projectors, each projector scans part of the defined area.

According to another aspect to the present invention there is provided a system for locating objects in a defined area useful for locating animals in a pen, the system comprising:
at least one projector, the projector is periodically scanning at least part of said defined area, wherein the projection is a narrow angle projection that is modulated with location's information about the location that is being projected;
plurality of self-location-units to be attached to any object located in the defined area, wherein the self-location-unit comprised of:
   a receiver capable to receive the projection;
   a decoding unit, capable to decode the projection's modulation, having the self locating; and
   a transmitter that transmits the decoded self-location; and
at least one stationary unit that receives the self-location from each object's self-location-unit and capable to display and/or store locations.

According to a preferred embodiment of the locating system, according to the present invention, the system is provided wherein the modulation includes height and angle information of the projection, from which the projected location can be defined and wherein the information is sequentially changes according the direction of the projection.

According to yet another aspect to the present invention there is provided a system for locating objects in a defined area, this system comprised of:
a projector, the projector periodically projects each pre-defined segment of the defined area, wherein the projection is a narrow angle projection that projects only one segment and is modulated with location information of the segment being projected;
plurality of self-location-units to be attached to any object located in the defined area, wherein said self-location-unit comprised of:
   a receiver capable to receive the projection;
   a decoding unit, capable to decode the projection's modulation, having the self locating segment; and
   a transmitter that transmits said self-location segment; and
at least one stationary unit that receives the self-location segment from each object's self-location-unit and capable to display and/or store the objects' location.

By another feature of the present invention the system is provided wherein the system is designed for locating animals, which are moving in a pen.

By yet another feature of the present invention the system is provided, wherein the self-location-unit is further capable to receive the neighbors segments' projections, that are crossing the space above the segment, enabling to recognize whether the animal is laying or standing.

By yet another feature of the present invention the system is provided, wherein the self-location-unit is further includes at least two polarized antennas, each antenna polarized to another direction, enabling to calculate the orientation of the animal in the pen's segment.

By a preferred embodiment, according to the present invention, the system is provided, wherein the modulation includes projection's height and angle information, from which the projected segment can be defined and wherein the information is sequentially changes according the direction of the projection.

By another preferred embodiment of the system, according to the present invention, the system is provided, wherein the narrow angle of the projector, is capable to change according to the segments size or according to the needed location's resolution.

By another preferred embodiment according to the present invention, the system is provided, further includes a plurality of projectors, each projector periodically projects part of the segments of the defined area.

By another preferred embodiment of the system, according to the present invention, the system is provided, wherein the stationary unit receives sequentially the transmissions from the self-location-units, enabling real time location of each object.

By yet another preferred embodiment of the system, according to the present invention, the system is provided, wherein the stationary unit samples, at a predetermined sequence, the location of each object and stores location and time of each sampling.

By yet another preferred embodiment of the system, according to the present invention, the system is provided, wherein the projection is an optical wave projection, RF projection, microwave projection, ultra-sound projection or any other kind of projection.

According to present invention, the systems also provide, in a preferred embodiment, wherein the self-location-unit includes an identification code and this code is attached to any transmission of the self-location unit in order to identify the object from which the transmission is received.

### BRIEF DESCRIPTION OF THE FIGURES

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the figures:

FIG. 1 illustrates the projection method, using two projectors that are projecting a pre defined segments area.

FIG. 2 illustrates the location method and system.

### DESCRIPTION OF THE PREFERRED EMBODIMENTS

The present invention is a method and a system for locating objects in a defined area. The present invention is useful to locate animals in a farm or animals in a pen.

According to the present invention, the defined area is scanned by a projection. Alternatively, the area is divided into pre-defined segments and each segment is projected or each group of segments is scanned by a projection.

The projection, which can be optical wave or radio signal or any other kind of projection, is a narrow angle projection and can be received only in the projected location. The projection is modulated in the information about the projected area. This modulation changes according to the projected area or according to the projected segment while scanning.

A self-location-unit, which can include an object's identification code, is attached to each object in the defined area. When the area or the segment in which the object is located is being projected, the unit receives the projection and decodes the modulation having its' self-location. The self-location-unit transmits its' self-location together with the identification code to a stationary station that receives and processes the transmission.

The principles and operation of the method and the system according to the present invention may be better understood with reference to the drawing and the accompanying description.

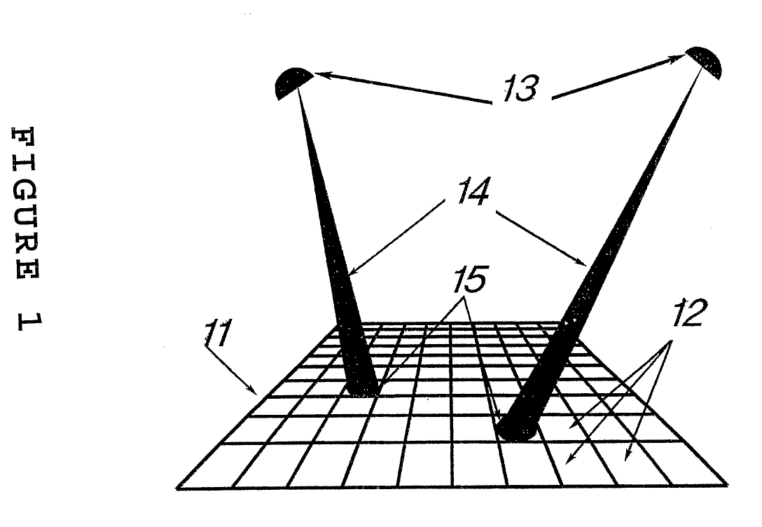

Referring now to the drawing, FIG. 1 illustrates the projection method, using two projectors that are projecting a pre defined segments area. The defined area 11 is divided into segments 12. Two projectors 13 are scanning the defined area 11, each projector 13 scans half of the segments 12. The projection 14 is a narrow angle projection and projects one segment 15 at a time. The projection 14 is modulated. The modulation can include projection's height and angle from which the projected segment 15 can be defined or include the projected segment 15 identification. Object with decoding capability that is located in a projected segment 15, can learn about its' self-location by decoding the modulation.

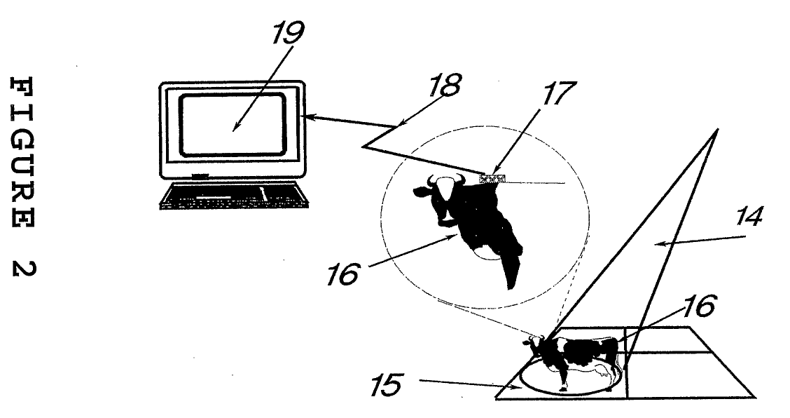

FIG. 2 illustrates the location method and system. In the illustrated time a segment 15 is projected by a narrow angle projection 14. A cow 16 is located in the projected segment 15 of a pen and a self-location-unit 17 is attached to this cow 16. The self-location-unit 17 has an identification code that transmits with any transmission. The unit 17 receives the projection 14 and decodes the self-location segment 15. The unit 17 transmits 18 to a stationary station 19 its' location segment 15 together with its' identification code. Now the stationary station realizes that the specific cow 16 is located in the specific segment 15. If the cow 16 will move to another segment, the unit 17 will be waiting until the new location will be projected and then the unit 17 will transmit 18 to the stationary station 19 its' new location.

Although the invention has been described in conjunction with specific embodiments thereof, it is evident that many alternatives, modifications and variations will be apparent to those skilled in the art, accordingly, it is intended to embrace all such alternatives, modifications and variations that fall within the spirit and broad scope of the appended claims.

What is claimed is:

1. A method for locating an object in a defined area, said method is comprised of the following steps:
projecting each pre-defined segment of said defined area by a narrow angle projection;
modulating said projection, wherein said modulation includes the location of the segment being projected;
attaching a self-location-unit to each object, said self-location-unit capable to receive said projection, decodes said modulation having the self location segment and transmits said self location; and
receiving each transmission, from each of said self-location-units, and storing each object's location segment.

2. The method of claim 1, wherein said self-location-unit further includes identification code, said identification code is attached to any transmission of said unit in order to identify the object from which the transmission is received.

3. The method of claim 1, useful for moving objects, further includes the step:
receiving sequentially said transmissions from said self-location-units, enabling real time location of each object.

4. The method of claim 3, useful for moving objects, further includes the step:
sequentially storing each object's location for further processing.

5. The method of claim 1, wherein said projection is done by a single projector that periodically scans the whole segments of said defined area and changes modulation in accordance with the location of the segment being projected.

6. The method of claim 5, wherein said scan is done by a plurality of projectors, each projector scans part of said defined area.

7. A system for locating objects in a defined area, said system comprising:
at least one projector, said projector is periodically scanning at least part of said defined area, wherein said projection is a narrow angle projection that is modulated with location's information about the location that is being projected;
plurality of self-location-units to be attached to any object that is located in said defined area, wherein said self-location-unit comprised of:
a receiver capable to receive said projection;
a decoding unit, capable to decode said projection's modulation, having the self locating; and
a transmitter that transmits said decoded self location; and
at least one stationary unit that receives said self location from each object's self-location-unit and capable to display and/or store said objects' location.

8. The system of claim 7, wherein said self-location-unit further includes identification code, said identification code is attached to any transmission of said unit in order to identify the object from which the transmission is received.

9. The system of claim 7, wherein said modulation includes height and angle information of said projection, from which said projected location can be defined and wherein said information is sequentially changes according the direction of said projection.

10. A system for locating objects in a defined area, said system comprising:
a projector, said projector is periodically projects each pre defined segment of said defined area, wherein said projection is a narrow angle projection that projects only one segment and is modulated with location information of the segment being projected;
plurality of self-location-units to be attached to any object that is located in said defined area, wherein said self-location-unit comprised of:
a receiver capable to receive said projection;
a decoding unit, capable to decode said projection's modulation, having the self locating segment; and
a transmitter that transmits said self location segment; and
at least one stationary unit that receives said self location segment from each object's self-location-unit and capable to display and/or store said objects' location.

11. The system of claim 10, wherein said self-location-unit further includes identification code, said identification code is attached to any transmission of said unit in order to identify the object from which the transmission is received.

12. The system of claim 11, wherein said system is designed for locating animals, which are moving in a pen.

13. The system of claim 12, wherein said self-location-unit is further capable to receive the neighbors segments' projections, that are crossing the space above said segment, enabling to recognize whether said animal is laying or standing.

14. The system of claim 12, wherein said self-location-unit is further includes at least two polarized antennas, each antenna polarized to another direction, enabling to calculate the orientation of said animal in said segment.

15. The system of claim 10, wherein said modulation includes height and angle information of said projection, from which said projected segment can be defined and wherein said information is sequentially changes according the direction of said projection.

16. The system of claim 10, wherein said narrow angle of said projector, is capable to change according to said segments size or according to the needed location's resolution.

17. The system of claim 10, further includes a plurality of projectors, each projector periodically projects part of the segments of said defined area.

18. The system of claim 10, wherein said stationary unit receives sequentially said transmissions from said self-location-units, enabling real time location of each object.

19. The system of claim 18, wherein said stationary unit samples, at a predetermined sequence, the location of each identified object and stores location and time of each sampling.

20. The system of claim 10, wherein said projection is an optical wave projection.

21. The system of claim 10, wherein said projection is RF projection or microwaves projection.

22. The system of claim 10, wherein said projection is an ultra-sound projection.
